(19) United States
(12) Patent Application Publication
(10) Pub. No.: US 2012/0305809 A1
(43) Pub. Date: Dec. 6, 2012

(54) APPARATUS AND METHOD FOR GENERATING EXTREME ULTRAVIOLET LIGHT

(75) Inventors: Masato MORIYA, Oyama-shi (JP); Osamu Wakabayashi, Hiratsuka-shi (JP)

(73) Assignee: GIGAPHOTON, INC.

(21) Appl. No.: 13/482,857

(22) Filed: May 29, 2012

(30) Foreign Application Priority Data
Jun. 2, 2011 (JP) 2011-124531
Apr. 19, 2012 (JP) 2012-095735

(51) Int. Cl. G21K 5/04

(52) U.S. Cl. 250/504 R

(57) ABSTRACT

An apparatus for generating extreme ultraviolet light is used with a first laser device for outputting a first laser beam. The apparatus includes a second laser device for outputting a second laser beam, a beam adjusting unit for causing beam axes of the first and second laser beams to substantially coincide with each other, a chamber, a target supply unit for supplying target materials into the chamber, a laser beam focusing optical system for focusing the first laser beam on the target material for plasma generation, an optical detection system for detecting the second laser beam and light from plasma, a focus position correction mechanism for correcting a first laser beam focusing position, and a target supply position correction mechanism for correcting a target material supplying position, and a controller for the focus position correction mechanism and the target supply position correction mechanism based on the optical detection system's detection.

### CROSS-REFERENCE TO RELATED APPLICATIONS

The present application claims priority from Japanese Patent Application No. 2011-124531 filed Jun. 2, 2011, and Japanese Patent Application No. 2012-095735 filed Apr. 19, 2012.

### BACKGROUND

1. Technical Field

This disclosure relates to an apparatus and a method for generating extreme ultraviolet (EUV) light.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used.

### SUMMARY

An apparatus according to one aspect of this disclosure for generating extreme ultraviolet light used with a first laser device configured to output a first laser beam may include: a second laser device configured to output a second laser beam; a beam adjusting unit configured to cause a beam axis of the first laser beam and a beam axis of the second laser beam to substantially coincide with each other; a chamber having a window through which the first and second laser beams are introduced into the chamber; a target supply unit configured to supply a target material to a predetermined region inside the chamber; a laser beam focusing optical system for focusing the first laser beam on the target material inside the chamber; an optical detection system for detecting the second laser beam and light emitted from plasma generated when the target material is irradiated with the first laser beam; a focus position correction mechanism configured to correct a position at which the first laser beam is focused by the laser beam focusing optical system; a target supply position correction mechanism configured to correct a position to which the target material is supplied; and a controller configured to control the focus position correction mechanism and the target supply position correction mechanism based on the detection result of the second laser beam and the light emitted from the plasma.

A method according to another aspect of this disclosure for generating extreme ultraviolet light in an apparatus that is used with a first laser device configured to output a first laser beam and includes a second laser device configured to output a second laser beam, a beam adjusting unit, a chamber, a target supply unit, a laser beam focusing optical system, an optical detection system, and a controller may include: detecting the second laser beam; detecting light emitted from plasma generated when a target material is irradiated with the first laser beam; controlling a position at which the first laser beam is focused by the laser beam focusing optical system based on the detection result of the second laser beam; and controlling a position to which the target material is supplied by the target supply unit based on the detection result of the light emitted from the plasma.

### BRIEF DESCRIPTION OF THE DRAWINGS

Hereinafter, selected embodiments of this disclosure will be described with reference to the accompanying drawings.

FIG. 1 schematically illustrates the configuration of an exemplary LPP type EUV light generation system.

FIG. 2 schematically illustrates the configuration of an EUV light generation system according to an embodiment of this disclosure.

FIG. 3 shows an image detected by an optical sensor when the center of a pulse laser beam coincides with the center of a target being irradiated with the pulse laser beam.

FIG. 4 shows an image detected by an optical sensor when the center of a pulse laser beam does not coincide with the center of a target being irradiated with the pulse laser beam.

FIG. 5 shows the relationship among the center of an image of a focused guide laser beam obtained through calculation, the center of an image of plasma-emitted light obtained through calculation, and an estimated image of the focused pulse laser beam in the state shown in FIG. 4.

FIG. 6 schematically illustrates the configuration of a optical detection system according to a first example.

FIG. 7 schematically illustrates the configuration of a optical detection system according to a second example.

FIG. 8 schematically illustrates the configuration of a optical detection system according to a third example.

FIG. 9 schematically illustrates the configuration of an optical system in a modification of the EUV light generation system of the embodiment of this disclosure.

FIG. 10 shows the relationship among an image of a guide laser beam at a pinhole, an image of plasma-emitted light, and an image of a pulse laser beam, which are imaged on the optical sensor shown in FIG. 9.

### DETAILED DESCRIPTION

Hereinafter, selected embodiments of this disclosure will be described in detail with reference to the accompanying drawings. The embodiments to be described below are merely illustrative in nature and do not limit the scope of this disclosure. Further, the configuration(s) and operation(s) described in each embodiment are not all essential in implementing this disclosure. Note that like elements are referenced by like reference numerals and characters, and duplicate descriptions thereof will be omitted herein. The embodiments of this disclosure will be illustrated following the table of contents below.

### Contents

### 1. Overview

### 2. Terms

### 3. Overview of EUV Light Generation System

### 3.1 Configuration

### 3.2 Operation

### 4. EUV Light Generation System Including Detection System for Guide Laser Beam and Plasma-Emitted Light

### 4.1 Configuration

### 4.2 Operation

### 4.3 Effect

### 4.4 Examples of Optical Detection System

### 4.4.1 First Example

### 4.4.2 Second Example

### 4.4.3 Third Example

### 5. Variation

### 5.1 Configuration

### 5.2 Operation

### 5.3 Effect

### 1. OVERVIEW

According to some of the embodiments of this disclosure, a guide laser beam and light emitted from plasma may be detected in an LPP type EUV light generation system, and based on the detection result, the position to which a target material is supplied and the position at which a laser beam for striking the target material is focused may be controlled.

### 2. TERMS

Terms used in this application may be interpreted as follows. The term “beam path” may refer to a path along which a laser beam travels. The term “beam cross-section” may refer to a region along a plane perpendicular to the travel direction of a laser beam, in which the beam intensity is equal to or higher than a predetermined value. The term “beam axis” may refer to an axis of a laser beam which passes through substantially the center of the beam cross-section. In a beam path of a laser beam, a direction or side closer to the laser device may be referred to as “upstream,” and a direction into which the laser beam travel may be referred to as “downstream.”

The term “plasma generation region” may refer to a three-dimensional space predefined as a space in which plasma is to be generated.

The term “obscuration region” may refer to a three-dimensional region that is a shadow of EUV light. Typically, the EUV light that passes through the obscuration region is not used for exposure in an exposure apparatus.

The term “droplet” may refer to a liquid droplet of a molten target material. Accordingly, the shape thereof may be substantially spherical due to its surface tension.

### 3. OVERVIEW OF EUV LIGHT GENERATION SYSTEM

### 3.1 Configuration

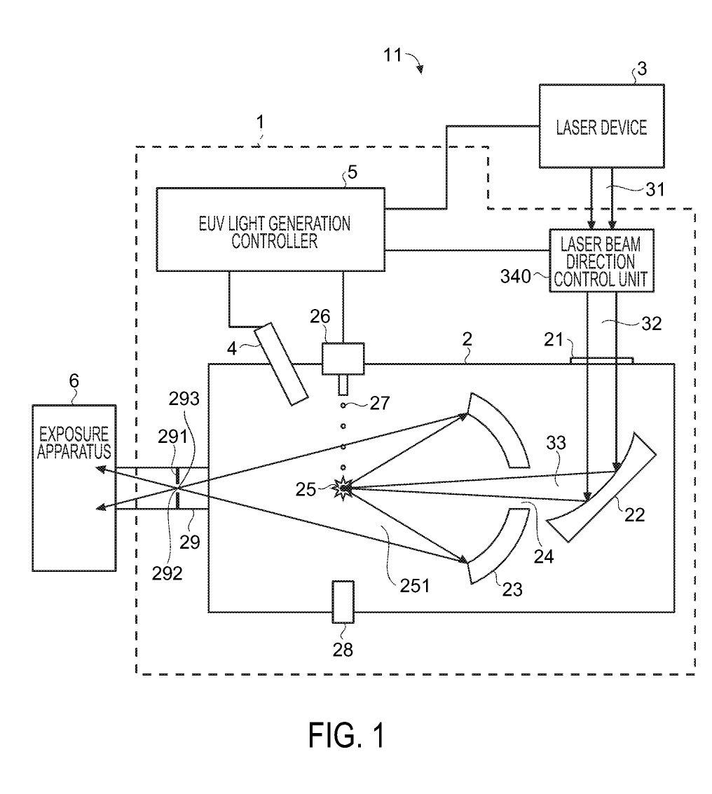

FIG. 1 schematically illustrates the configuration of an exemplary LPP type EUV light generation system. An LPP type EUV light generation apparatus 1 may be used with at least one laser device 3. Hereinafter, a system that includes the EUV light generation apparatus 1 and the laser device 3 may be referred to as an EUV light generation system 11. As illustrated in FIG. 1 and described in detail below, the EUV light generation system 11 may include a chamber 2, a target supply unit 26, and so forth. The chamber 2 may be airtightly sealed. The target supply unit 26 may be mounted onto the chamber 2 so as to, for example, penetrate a wall of the chamber 2. A target material to be supplied by the target supply unit 26 may include, but is not limited to, tin, terbium, gadolinium, lithium, xenon, or any combination thereof.

The chamber 2 may have at least one through-hole or opening formed in its wall, and a pulse laser beam 32 may travel through the through-hole/opening into the chamber 2. Alternatively, the chamber 2 may be provided with a window 21, through which the pulse laser beam 32 may travel into the chamber 2. An EUV collector mirror 23 having a spheroidal surface may be provided inside the chamber 2, for example. The EUV collector mirror 23 may have a multi-layered reflective film formed on the spheroidal surface thereof. The reflective film may include a molybdenum layer and a silicon layer being laminated alternately. The EUV collector mirror 23 may have a first focus and a second focus, and preferably be positioned such that the first focus lies in a plasma generation region 25 and the second focus lies in an intermediate focus (IF) region 292 defined by the specification of an external apparatus, such as an exposure apparatus 6. The EUV collector mirror 23 may have a through-hole 24 formed at the center thereof, and a pulse laser beam 33 may travel through the through-hole 24 toward the plasma generation region 25. The beam cross-section of the pulse laser beam 33 may be substantially circular.

The EUV light generation system 11 may further include an EUV light generation controller 5 and a target sensor 4. The target sensor 4 may have an imaging function and detect at least one of the presence, the trajectory, and the position of a target 27.

Further, the EUV light generation system 11 may include a connection part 29 for allowing the interior of the chamber 2 and the interior of the exposure apparatus 6 to be in communication with each other. A wall 291 having an aperture 293 may be provided inside the connection part 29, and the wall 291 may be positioned such that the second focus of the EUV collector mirror 23 lies in the aperture 293 formed in the wall 291.

The EUV light generation system 11 may also include a laser beam direction control unit 340, a laser beam focusing mirror 22, and a target collector 28 for collecting targets 27. The laser beam direction control unit 340 may include an optical element for defining the direction into which the pulse laser beam 32 travels and an actuator for adjusting the position and the orientation (posture) of the optical element.

### 3.2 Operation

With continued reference to FIG. 1, a pulse laser beam 31 outputted from the laser device 3 may pass through the laser beam direction control unit 340 and be outputted therefrom as a pulse laser beam 32 after having its direction optionally adjusted. The pulse laser beam 32 may travel through the window 21 and enter the chamber 2. The pulse laser beam 32 may travel inside the chamber 2 along at least one beam path from the laser device 3, be reflected by the laser beam focusing mirror 22, and strike at least one target 27 as a pulse laser beam 33.

The target supply unit 26 may be configured to output the target(s) 27 in the form of droplets toward the plasma generation region 25 inside the chamber 2. The target 27 may be irradiated by at least one pulse of the pulse laser beam 33. Upon being irradiated with the pulse laser beam 33, the target 27 may be turned into plasma, and rays of light 251 including EUV light may be emitted from the plasma. At least the EUV light included in the light 251 may be reflected selectively by the EUV collector mirror 23. The EUV light reflected by the EUV collector mirror 23 may travel through the intermediate focus region 292 and be outputted to the exposure apparatus 6. Here, the target 27 may be irradiated by multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of the timing at which the target 27 is outputted and the direction into which the target 27 is outputted. Furthermore, the EUV light generation controller 5 may be configured to control at least one of the timing at which the laser device 3 oscillates, the direction in which the pulse laser beam 31 travels, and the position at which the pulse laser beam 33 is focused. It will be appreciated that the various controls mentioned above are merely examples, and other controls may be added as necessary.

### 4. EUV LIGHT GENERATION SYSTEM INCLUDING DETECTION SYSTEM FOR GUIDE LASER BEAM AND PLASMA-EMITTED LIGHT

### 4.1 Configuration

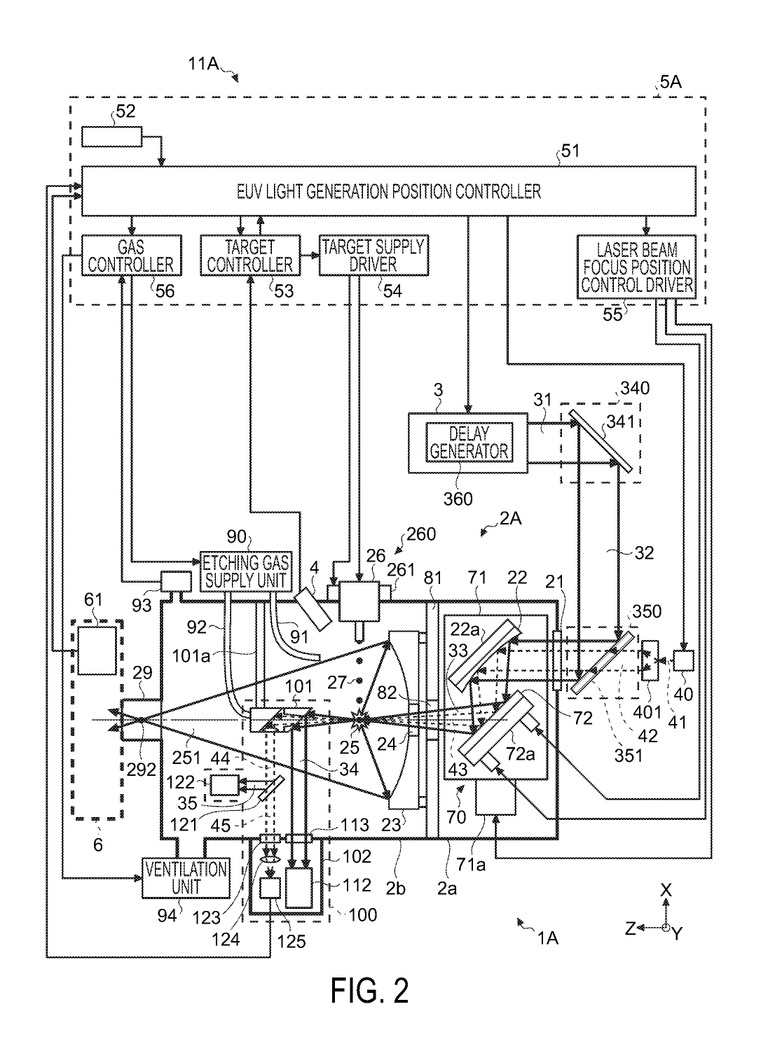

An EUV light generation system according to an embodiment will now be described in detail with reference to the drawings. FIG. 2 schematically illustrates the configuration of an EUV light generation system 11A. As shown in FIG. 2, the EUV light generation system 11A may include an EUV light generation apparatus 1A and the laser device 3.

The EUV light generation apparatus 1A may include a beam delivery unit 340, a beam adjusting unit 350, and a chamber 2A. Further, the EUV light generation apparatus 1A may include a guide laser device 40 and a beam expander 401. The EUV light generation apparatus 1A may further include an EUV light generation controller 5A.

The laser device 3 may be configured to output the pulse laser beam 31 at a predetermined repetition rate. When the laser device 3, for example, includes a CO₂ gas as a gain medium, the wavelength of the pulse laser beam 31 may be around 10.6 μm. The beam delivery unit 340 may include a high-reflection mirror 341 for defining the direction into which the pulse laser beam 32 travels. The high-reflection mirror 341 may be coated with a film configured to reflect the pulse laser beam 31 with high reflectance. The beam delivery unit 340 may further include an actuator (not shown) for adjusting the position and the orientation of the high-reflection mirror 341. The beam delivery unit 340 may be configured to cause the pulse laser beam 32 to be introduced into a predetermined beam path.

The guide laser device 40 may be configured to output a guide laser beam 41. The guide laser device 40 may be a semiconductor laser. However, this disclosure is not limited thereto, and a light source aside from a laser, such as an incoherent light source (e.g., light emitting diode (LED)), may also be used as the guide laser device 40. The guide laser beam 41 may be a pulsed beam or a continuous wave beam. When the guide laser beam 41 is a pulsed beam, the EUV light generation controller 5A may synchronize the timing at which the target 27 is outputted from the target supply unit 260 and the timing of the guide laser beam 41. In the description to follow, the guide laser beam 41 is assumed to be a continuous wave beam. The wavelength of the guide laser beam 41 may be shorter than the wavelength of the pulse laser beam 31. The guide laser beam 41 may, for example, be visible radiation. The wavelength of the guide laser beam 41 may, for example, be around 500 nm. The guide laser beam 41 may preferably be at a wavelength suitable for photosensitivity of the optical sensor 125, which will be described in detail later. The beam expander 401 may be provided in a beam path of the guide laser beam 41.

The beam adjusting unit 350 may include a dichroic mirror 351. The dichroic mirror 351 may be coated on a first surface thereof with a film configured to reflect the pulse laser beam 32 with high reflectance and transmit a guide laser beam 42 with high transmittance. The dichroic mirror 351 may be coated on a second surface thereof with a film configured to transmit the guide laser beam 42 with high transmittance. The dichroic mirror 351 may be positioned such that the pulse laser beam 32 is incident on the first surface thereof and the guide laser beam 42 is incident on the second surface thereof. The substrate of the dichroic mirror 351 may, for example, include diamond. The beam adjusting unit 350 may be provided such that the pulse laser beam 32 reflected thereby and the guide laser beam 42 transmitted therethrough are guided toward the chamber 2A along substantially the same beam path. This may also be applicable even when an incoherent light source is used as the guide laser device 40.

The chamber 2A may include the window 21, a laser beam focusing optical system 70, a target supply unit 260, the target sensor 4, the EUV collector mirror 23, and the connection part 29. The window 21 may be coated with a film configured to reduce reflectance of the laser beams incident thereon. Further, the chamber 2A may include an optical detection system 100, an etching gas supply unit 90, a manometer 93, and a ventilation unit 94.

The laser beam focusing optical system 70 may include the laser beam focusing mirror 22 and a high-reflection mirror 72. The laser beam focusing optical system 70 may be provided with a focus position correction mechanism. The focus position correction mechanism may include a plate 71, a plate moving mechanism 71a, a mirror holder 22a, and a holder 72a provided with an automatic tilt mechanism. The laser beam focusing mirror 22 may be an off-axis paraboloidal mirror. The laser beam focusing mirror 22 may be mounted to the plate 71 through the mirror holder 22a. The high-reflection mirror 72 may be mounted to the plate 71 through the holder 72a. The plate moving mechanism 71a may be configured to move the laser beam focusing mirror 22 and the high-reflection mirror 72 along with the plate 71. The laser beam focusing mirror 22 and the high-reflection mirror 72 may be positioned such that the laser beams 32 and 42 are first incident on the laser beam focusing mirror 22 and then on the high-reflection mirror 72 and such that the laser beams 33 and 43 reflected by the high-reflection mirror 72 are focused in the plasma generation region 25.

The plate moving mechanism 71a may be configured to move the plate 71 to thereby adjust the focus of the laser beams 33 and 43 in the Z-direction. The holder 72a may be configured to adjust the tilt angle of the high-reflection mirror 72 to thereby adjust the focus of the laser beams 33 and 43 along the XY-plane. The aforementioned adjustments may be controlled by the EUV light generation controller 5A. The details of the control will be given later.

The target supply unit 260 may include a target generator 26. The target generator 26 may be provided with a two-axis moving mechanism 261. The target generator 26 may be configured to output targets 27 in the form of droplets toward the plasma generation region 25. The two-axis moving mechanism 261 may be configured to move the target generator 26 to thereby adjust the position to which the targets 27 are supplied from the target generator 26. The two-axis moving mechanism 261 may be configured to move the target generator 26 in accordance with the control by the EUV light generation controller 5A.

The optical detection system 100 may include a mirror unit 101, a beam dump 112, a dichroic mirror 121, a beam dump 122, an imaging optical system 124, and an optical sensor 125. The mirror unit 101 may be supported by a mirror holder 101a. The mirror unit 101 may be provided in the obscuration region. The details of the internal structure of the mirror unit 101 will be given later. The beam dump 112, the imaging optical system 124, and the optical sensor 125 may be housed in a sub-chamber 102 connected to the chamber 2A. The chamber 2A and the sub-chamber 102 may be optically connected through windows 113 and 123.

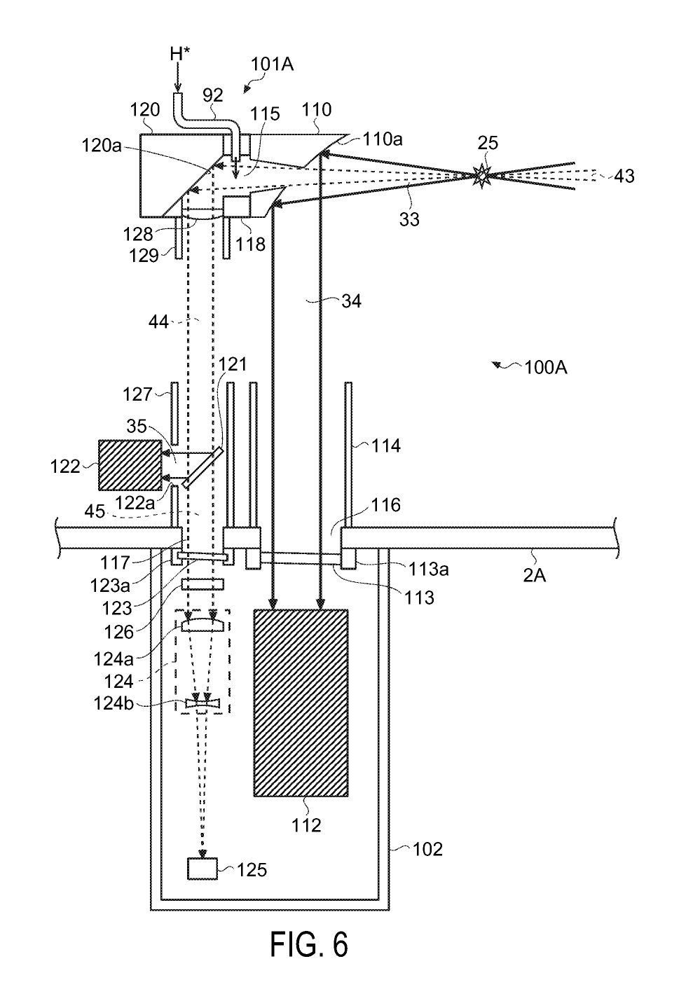

The etching gas supply unit 90 may be configured to supply an etching gas into the chamber 2A under the control of the EUV light generation controller 5A. When tin is used as the target material, a gas containing a hydrogen gas or hydrogen radicals may be used as the etching gas. The etching gas may be diluted with a buffer gas containing an inert gas, such as N₂, He, Ne, and Ar. The etching gas supply unit 90 may include introduction pipes 91 and 92. The introduction pipe 91 may be configured to introduce the etching gas toward the reflective surface of the EUV collector mirror 23. More specifically, the gas introduction pipe 91 may be shaped such that a gas outlet of the introduction pipe 91 is orientated toward the reflective surface of the EUV collector mirror 23, for example. The introduction pipe 92 may be configured to introduce the etching gas H* into a space 115 (see FIG. 6, for example) formed inside the mirror unit 101. With this, the target material deposited on the optical elements may be etched. It should be noted that in FIGS. 2 and 6, the parts at which the introduction pipe 92 is connected to the mirror unit 101 differ, but the connection may be made at either part.

The manometer 93 may be configured to measure the pressure inside the chamber 2A. The manometer 93 may send the measured pressure to the EUV light generation controller 5A. The ventilation unit 94 may discharge the gas inside the chamber 2A under the control of the EUV light generation controller 5A.

The EUV light generation controller 5A may include an EUV light generation position controller 51, a reference clock generator 52, a target controller 53, a target supply driver 54, a laser beam focus position control driver 55, and a gas controller 56. The EUV light generation position controller 51 may be connected to the reference clock generator 52, the laser beam focus position control driver 55, the target controller 53, the laser device 3, an exposure apparatus controller 61, and the optical detection system 100. The target controller 53 may be connected to the target supply driver 54. The target supply driver 54 may be connected to the target supply unit 260 and/or the two-axis moving mechanism 261. The laser beam focus position control driver 55 may be connected to the laser beam focusing optical system 70 and/or the focus position correction mechanism. The gas controller 56 may be connected to the etching gas supply unit 90, the manometer 93, and the ventilation unit 94.

The interior of the chamber 2A may be divided into an upstream space 2a and a downstream space 2b by a partition 81. The plasma generation region 25 may be set in the downstream space 2b. The partition 81 may serve to reduce the amount of debris of the target material generated in the space 2b entering the upstream space 2a. A communication hole 82 may be formed in the partition 81, through which the laser beams 33 and 43 from the laser beam focusing optical system 70 provided in the space 2a may travel into the space 2b. The partition 81 may preferably be positioned such that the center of the communication hole 82 and the center of the through-hole 24 in the EUV collector mirror 23 are aligned in the beam path of the laser beams 33 and 43.

### 4.2 Operation

The operation of the EUV light generation system 11A shown in FIG. 2 will now be described. The EUV light generation system 11A may operate under the control of the EUV light generation controller 5A. The EUV light generation controller 5A may receive an instruction from the exposure apparatus controller 61 pertaining to the position at which the light 251 is to be emitted (an EUV light generation instruction position). The EUV light generation controller 5A may control each component so that the light 251 is emitted in the EUV light generation instruction position.

The EUV light generation controller 5A may cause the guide laser device 40 to oscillate. With this, the guide laser beam 41 may be outputted from the guide laser device 40. The guide laser beam 41 may enter the beam expander 401, be expanded in diameter, and be outputted therefrom as a guide laser beam 42. The guide laser beam 42 may then be transmitted through the dichroic mirror 351 of the beam adjusting unit 350.

The guide laser beam 42 may then enter the chamber 2 through the window 21 along substantially the same beam path as the pulse laser beam 32. The guide laser beam 42 may be reflected sequentially by the laser beam focusing mirror 22 and the high-reflection mirror 72, and as a guide laser beam 43, may travel through the communication hole 82 and the through-hole 24, and be focused in the plasma generation region 25. Thereafter, the diverging guide laser beam 43 may enter the mirror unit 101 of the optical detection system 100.

Upon receiving an EUV light generation request signal, the EUV light generation controller 5A may input the EUV light generation request signal to the target controller 53. Upon receiving the EUV light generation request signal, the target controller 53 may send an output signal for the target 27 to the target generator 26 through the target supply driver 54. The target generator 26 may then output the target 27 at a timing in accordance with the inputted output signal.

The target sensor 4 may be configured to detect data for calculating the position and the timing at which the target 27 may pass through the plasma generation region 25. The detected values may be inputted to the target controller 53. The target controller 53 may control the target supply unit 260 in accordance with the inputted detected values. Further, the target controller 53 may output the inputted detected values to the EUV light generation position controller 51. The EUV light generation position controller 51 may send a trigger signal to the laser device 3 in accordance with the inputted detected values. The laser device 3 may output the pulse laser beam 31 at a timing delayed for a predetermined time from the trigger signal so that the target 27 is irradiated with the pulse laser beam 33 at a timing at which the target 27 reaches the EUV light generation instruction position. The laser device 3 may include a delay generator 360. The delay generator 360 may adjustably hold a delay time of an output timing of the pulse laser beam 31 with respect to the detection timing of the target 27.

The pulse laser beam 31 outputted from the laser device 3 may be reflected by the high-reflection mirror 341 of the beam delivery unit 340 and by the dichroic mirror 351 of the beam adjusting unit 350. Then, the pulse laser beam 32 may enter the chamber 2A through the window 21. The pulse laser beam 32 may then be reflected sequentially by the laser beam focusing mirror 22 and the high-reflection mirror 72, and be focused on the target 27 in the plasma generation region 25.

Upon being irradiated with the pulse laser beam 33, the target 27 may be turned into plasma, and the light 251 including the EUV light may be emitted from the plasma.

The mirror unit 101 may include first and second reflective surfaces. The first reflective surface may be arranged upstream from the second reflective surface. A through-hole may be formed in the first reflective surface, through which the guide laser beam 43 passes. Light 34 reflected by the first reflective surface may include the pulse laser beam 33 and the light 251. The reflected light 34 may then be transmitted through the window 113 and be absorbed by the beam dump 112.

Light 44 reflected by the second surface of the mirror unit 101 may include the guide laser beam 43, the pulse laser beam 33, and the light 251. The dichroic mirror 121 provided in the path of the light 44 may transmit light 45 that includes the guide laser beam 43 and a part of the light 251 and reflect remaining light 35. Here, in FIG. 2, the guide laser beam 43 and the light 44 are indicated by the same broken lines, but this does not mean that the guide laser beam 43 and the light 44 are identical. The light 35 reflected by the dichroic mirror 121 may include a part of the pulse laser beam 33 which has passed through the plasma generation region 25. The reflected light 35 may be absorbed by the beam dump 122. The light 45 transmitted through the dichroic mirror 121 may be transmitted through the window 123, and be imaged on the photosensitive surface of the optical sensor 125 by the imaging optical system 124. This image at the focus of the light 45 may include the image of the guide laser beam 43 at its focus and the image of the light 251. The optical sensor 125 may input the detected image data to the EUV light generation position controller 51. Here, in place of the imaging optical system 124, a focusing mirror may be used.

The EUV light generation position controller 51 may calculate the size (e.g., the width and/or the area) and the center of the image of the guide laser beam 43 at its focus from the inputted data. The EUV light generation position controller 51 may control the focus position correction mechanism such that the center of the image of the guide laser beam 43 at its focus coincides with the EUV light generation instruction position received from the exposure apparatus controller 61. Here, the coordinate system of the image inputted from the optical sensor 125 may be converted as necessary so that the EUV light generation instruction position can be specified. The EUV light generation position controller 51 may also be configured to control the laser beam focusing optical system 70 so that the size of the image of the guide laser beam 43 at its focus becomes a predetermined size. The predetermined size may be held in the EUV light generation position controller 51 or may be given from the exposure apparatus controller 61. The EUV light generation position controller 51 may control the focus position correction mechanism through the laser beam focus position control driver 55. The laser beam focus position control driver 55 may send driving signals to the holder 72a and the plate moving mechanism 71a under the control of the EUV light generation position controller 51. For example, the EUV light generation position controller 51 may modify the tilt angles of the high-reflection mirror 72 in two directions through the holder 72a based on the information on the center of the image of the guide laser beam 43 at its focus. One of the two directions may be a rotational direction about the Y-axis, and the other direction may be a rotational direction about an axis that is perpendicular to the Y-axis and that lies on a plane parallel to the reflection surface of the high-reflection mirror 72. Further, the EUV light generation position controller 51 may move the plate 71 in the Z-direction through the plate moving mechanism 71a based on the information on the size of the image of the guide laser beam 43 at its focus. The movement of the plate 71 may, for example, be controlled as follows. First, a difference between the size of the image of the guide laser beam 43 at its focus and the predetermined size may be calculated. Then, the plate 71 may be moved in one direction along the Z-direction for a predetermined amount, and the difference may be calculated again. At this time, if the difference is larger than the difference calculated first, the plate 71 may be moved in the other direction along the Z-direction for an amount that is slightly larger than the aforementioned predetermined amount. If the difference becomes smaller, the plate 71 may further be moved in the same direction for a smaller amount. Such an operation may be repeated until the difference becomes equal to or smaller than a predetermined amount. In this way, the focus of the guide laser beam 43 may be adjusted, and in turn the focus of the pulse laser beam 33 may be adjusted.

Further, the EUV light generation position controller 51 may calculate the size (e.g., the width and/or the area) and the center of the image from the image data of the light 251. The EUV light generation position controller 51 may control the target supply unit 260 and the laser device 3 such that the center of the image of the light 251 coincides with the EUV light generation instruction position received from the exposure apparatus controller 61. Further, the EUV light generation position controller 51 may be configured to control the two-axis moving mechanism 261 such that the size of the image of the light 251 becomes a predetermined size. The predetermined size may be held in the EUV light generation position controller 51 or may be given from the exposure apparatus controller 61. The EUV light generation position controller 51 may control the target supply unit 260 through the target supply driver 54. The target supply driver 54 may send a driving signal to the two-axis moving mechanism 261 under the control of the target controller 53. For example, the EUV light generation position controller 51 may move the target generator 26 in the Y-direction through the two-axis moving mechanism 261 based on the information on the center of the light 251. Further, the EUV light generation position controller 51 may output a signal to the laser device 3 to correct the delay time for the output timing of the pulse laser beam 31 with respect to the output timing of the target 27 based on the information on the center of the light 251. Based on this signal, the laser device 3 may correct the delay time held in the delay generator 360. Further, the EUV light generation position controller 51 may move the target generator 26 in the Z-direction through the two-axis moving mechanism 261 based on the information on the size of the light 251. The control of the movement of the target generator 26 in the Z-direction may, for example, be similar to the above-described control of the plate 71. In this way, the position to which the target 27 is supplied may be corrected.

The gas controller 56 may control the etching gas supply unit 90 and the ventilation unit 94 based on the value inputted from the manometer 93. With this, the gas pressure inside the chamber 2A may be retained at a predetermined low pressure, and at the same time a sufficient amount of the etching gas may be introduced into the chamber 2A.

Here, the image of the guide laser beam 43 at its focus imaged on the optical sensor 125 and the image of the light 251 will be discussed.

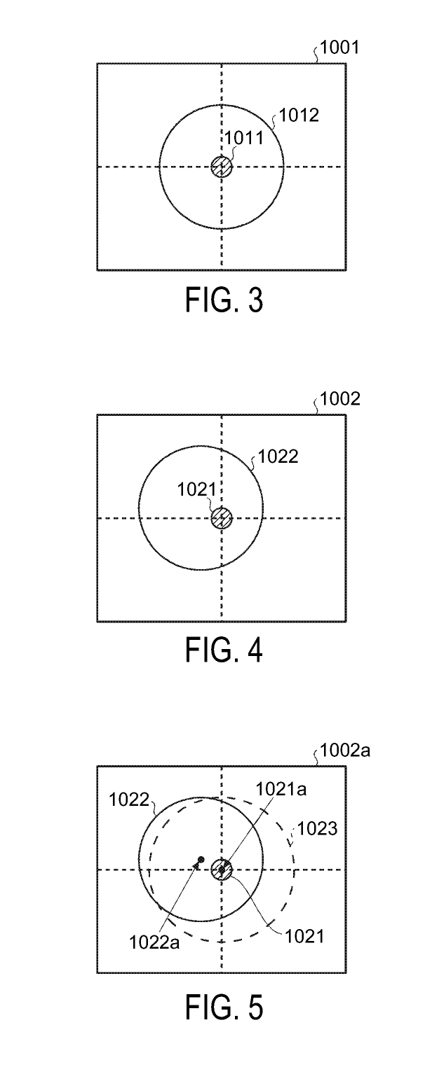

FIG. 3 shows an example of an image 1001 to be detected by an optical sensor when the center of the pulse laser beam coincides with the center of the target being irradiated with the pulse laser beam. In FIG. 3, the center of an image 1011 of the guide laser beam 43 at its focus may substantially coincide with the center of an image 1012 of the light 251, and the respective centers may be detected around an ideal position. As stated above, information on the position at which the light 251 is to be generated may be given from the exposure apparatus controller 61. The EUV light generation position controller 51 may determine through calculation which position the specified generation position corresponds to in the coordinate system of the image obtained by the optical sensor 125, and store the determined position as the ideal position in a memory (not shown) or the like. In FIGS. 3 through 5, the intersection of the dotted lines may be set as the ideal positions, respectively. As shown in FIG. 3, it may be preferable that the image 1011 and the image 1012 are captured in the same image. For example, when the optical sensor 125 is configured of a CCD, the image 1011 and the image 1012 may be captured in the same image by appropriately selecting the capture timing and the exposure time. Alternatively, the image 1011 and the image 1012 may be captured at different timings, and the two images may be made into a composite image. Further alternatively, the image 1011 and the image 1012 may be captured at different timings, and the respective centers of the images 1011 and 1012 may be calculated separately. When the image 1011 and the image 1012 are captured at different timings, the respective capture timings may preferably be close to each other.

FIG. 4 shows an example of an image 1002 to be detected by an optical sensor when the center of the pulse laser beam does not coincide with the center of the target being irradiated with the pulse laser beam. As shown in FIG. 4, in this case, the center of an image 1021 of the guide laser beam 43 at its focus may not coincide with the center of an image 1022 of the light 251, and the center of the image 1022 may be offset from the ideal position.

FIG. 5 shows an example of an image 1002a of the relationship among the center of the image of the guide laser beam at its focus obtained through calculation, the center of the image of the plasma-emitted light obtained through calculation, and the estimated image 1023 of the pulse laser beam in the state shown in FIG. 4. The EUV light generation position controller 51 may control the focus of the pulse laser beam 33 and the position to which the target 27 is supplied based on such data as shown in FIG. 5. With this, the center 1021a of the image 1021 may coincide with the center 1022a of the image 1022. More specifically, in FIG. 5, for example, the center 1021a of the image 1021 is detected around the ideal position; thus, it is speculated that the pulse laser beam 33 is appropriately focused at the ideal position. On the other hand, the center 1022a of the image 1022 is not detected around the ideal position; thus, it is speculated that the target 27 is not supplied to the ideal position. Thus, the direction and the degree to which the center 1022a is offset from the ideal position may, for example, be calculated, and based on the calculation result, the position to which the target 27 has been supplied at the time of irradiation may be estimated. In the case shown in FIG. 5, since the center 1022a is offset to the upper left from the ideal position, it is speculated that the target 27 has been irradiated with the pulse laser beam 33 at a position offset to the lower right from the ideal position. Accordingly, the position to which a subsequent target 27 is to be supplied may be adjusted toward the upper left. The amount of adjustment to be made may be determined based on the relative position of and the relative distance among at least the target supply unit 260, the mirror unit 101, and the optical sensor 125. Without being limited to the above example, the determination may be made in accordance with the system to be implemented. Here, as in the control of the supply position of the target 27, the focus of the pulse laser beam 33 may be controlled similarly. Further, in place of the centers of the respective images, the centroids of the respective images may be obtained.

### 4.3 Effect

With the above configuration and operation, the guide laser beam 43 and the light 251 may be detected by the optical sensor 125. Through this, the focus of the pulse laser beam 33 and the position of the target 27 when irradiated with the pulse laser beam 33 may be detected.

Based on this detection result, the position at which the pulsed laser beam 33 is focused and the position to which the target 27 is supplied may be controlled. Accordingly, generation of the light 251 may be controlled with high precision.

Further, when a continuous wave laser beam is used as the guide laser beam 43, the focus of the pulse laser beam 33 may be controlled without outputting the pulse laser beam 31.

### 4.4 Examples of Optical Detection System

### 4.4.1 First Example

### 4.4.1.1 Configuration

FIG. 6 schematically illustrates the configuration of an optical detection system 100A of a first example. As shown in FIG. 6, the optical detection system 100A may include a mirror unit 101A, the window 113, the beam dump 112, the dichroic mirror 121, the beam dump 122, the window 123, the imaging optical system 124, and the optical sensor 125. The optical detection system 100A may further include baffles 114 and 127.

The mirror unit 101A may include mirror blocks 110 and 120, a lens block 118, a lens 128, and a baffle 129. The mirror block 110 may be provided upstream from the mirror block 120, that is, toward the plasma generation region 25.

The lens block 118 may be provided between the mirror block 110 and the mirror block 120. The lens 128 and the baffle 129 may be fixed to the lens block 118. The lens block 118 may be hollow so as not to block the guide laser beam 43. The lens block 118 may be provided with a heat carrier pipe (not shown), through which a heat carrier may circulate. With this, a rise in temperature of the lens block 118 caused by the irradiation with the laser beam or the scattered rays of the laser beam may be suppressed.

The base material of the mirror blocks 110 and 120 may be a material with high heat-conductivity, such as copper (Cu). Further, each of the mirror blocks 110 and 120 may be coated with a material, such as molybdenum (Mo), having low reactivity with the target material. Each of the mirror blocks 110 and 120 may be provided with a heat carrier pipe (not shown), through which a heat carrier may circulate. With this, a rise in temperature of the respective mirror blocks 110 and 120 caused by the irradiation with the laser beam or the scattered rays of the laser beam may be suppressed.

The mirror block 110 may include an off-axis paraboloidal mirror 110a. A space 115 may be formed in the mirror block 110 along the direction in which the guide laser beam 43 may travel. The mirror block 110 may be positioned such that the focus of the off-axis paraboloidal mirror 110a substantially coincides with the plasma generation region 25.

The light 34 reflected by the mirror block 110 may enter the sub-chamber 102 through a communication hole 116 formed in the chamber 2A. The communication hole 116 may be covered by the window 113. The window 113 may be formed of diamond, and may be coated with anti-reflective films for the wavelength corresponding to the wavelength of the laser beams on both sides thereof. The window 113 may be held by the window holder 113a attached to the outer wall of the chamber 2A. The cylindrical baffle 114 may be provided on the inner wall of the chamber 2A so as to surround the window 113. With this, deposition of debris onto the window 113 may be reduced. The baffle 114 may be provided with an introduction pipe (not shown), through which the etching gas may be supplied from the etching gas supply unit 90. The inner diameter of the baffle 114 may preferably be larger than the beam diameter of the light 34 reflected by the off-axis paraboloidal mirror 110a of the mirror block 110. The light 34 that has entered the sub-chamber 102 through the window 113 may be absorbed by the beam dump 112. The beam dump 112 may be provided with an energy sensor for detecting the energy of the entering laser beam. A heat carrier (not shown) may circulate in the beam dump 112. A commercially available laser power meter head may be used as the beam dump 112.

The mirror block 120 may be positioned such that the guide laser beam 43 is reflected at an angle of approximately 45 degrees by a reflective surface 120a. The lens 128, the dichroic mirror 121, the window 123, the filter 126, the imaging optical system 124, and the optical sensor 125 may be arranged in this order along the path of the light 44 reflected by the mirror block 120.

The lens 128 may be positioned such that the focus thereof along the beam path of the guide laser beam 43 substantially coincides with the plasma generation region 25. The lens 128 may collimate the light 44. The lens 128 may be made of diamond. The cylindrical baffle 129 may be provided on the outer wall of the lens block 118 so as to surround the lens 128. With this, deposition of debris onto the lens 128 may be reduced. The baffle 129 may be provided with an introduction pipe (not shown), through which the etching gas may be supplied from the etching gas supply unit 90.

The light 44 transmitted through the lens 128 may be incident on the dichroic mirror 121. The dichroic mirror 121 may be configured to transmit the guide laser beam 43 and a part of the light 251 and reflect the remaining light 35. The wavelength of the part of the light 251 which is transmitted through the dichroic mirror 121 may be in the range of visible radiation. The dichroic mirror 121 may be made of diamond. The light 35 reflected by the dichroic mirror 121 may be absorbed by the beam dump 122. A heat carrier (not shown) may circulate in the beam dump 122.

The light 45 transmitted through by the dichroic mirror 121 may enter the sub-chamber 102 through the communication hole 117 formed in the chamber 2A. The communication hole 117 may be covered by the window 123. The window 123 may be formed of diamond, and may be coated on both sides thereof with anti-reflective films for the wavelength sensitive to the optical sensor 125. The window 123 may be held by the window holder 123a attached to the outer wall of the chamber 2A. The cylindrical baffle 127 may be provided on the inner wall of the chamber 2A so as to surround the window 123. With this, deposition of debris onto the window 123 may be reduced. The baffle 127 may be provided with an introduction pipe (not shown), through which the etching gas may be supplied from the etching gas supply unit 90. Further, a through-hole 122a may be formed in the baffle 127, through which the light 35 reflected by the dichroic mirror 121 may travel toward the beam dump 122.

The filter 126, the imaging optical system 124, and the optical sensor 125, collectively serving as an optical detection unit, may be provided inside the sub-chamber 102. The filter 126 may be an optical bandpass filter which allows a part of the guide laser beam 43 and a part of the light 251 (see FIG. 2) to be transmitted therethrough. For example, the filter 126 may be configured to transmit visible radiation. The imaging optical system 124 may include a convex lens 124a and a concave lens 124b. The optical sensor 125 may be positioned such that the imaging plane of the imaging optical system 124 lies on the photosensitive surface of the optical sensor 125. The optical sensor 125 may be a two-dimensional sensor, such as a CCD or a PSD.

A gas outlet of the introduction pipe 92 connected to the etching gas supply unit 90 (see FIG. 2) may be positioned in the space 115 inside the mirror unit 101A. The etching gas H* may be introduced into the space 115, whereby debris deposited on the reflective surface 120a of the mirror block 120 and the surface of the lens 128 may be removed. Alternatively, an inert gas may be introduced into the space 115 from an inert gas supply unit (not shown) in order to prevent dust or the like from adhering onto the optical elements. The inert gas may be a noble gas, such as N₂, He, Ne, or Ar. In either case, a discharge port (not shown) may preferably be provided in the sub-chamber 102 so as to discharge the introduced gas. When the etching gas H* is introduced into the space 115, an appropriate scrubber may preferably be connected to the discharge port. When the substance to be etched is Sn and the etching gas H* is hydrogen, stannane (SnH₄) may be produced through the etching reaction.

### 4.4.1.2 Operation

The general operation of the optical detection system 100A shown in FIG. 6 will now be described. The beam axis of the guide laser beam 43 may substantially coincide with the beam axis of the pulse laser beam 33. The guide laser beam 43 may once be focused in the plasma generation region 25, and then the diverging guide laser beam 43 may travel through the space 115 in the mirror block 110. The guide laser beam 43 may then be incident on the reflective surface 120a of the mirror block 120 at substantially 45 degrees. The guide laser beam 43 reflected by the mirror block 120 may then be collimated through the lens 128. The collimated guide laser beam 43 may be transmitted through the dichroic mirror 121 and the window 123, and enter the optical detection unit inside the sub-chamber 102.

The center portion of the pulse laser beam 33 that has passed through the plasma generation region 25 may also travel through the space 115 and be reflected by the reflective surface 120a, as in the guide laser beam 43. The reflected pulse laser beam 33 may be transmitted through the lens 128, be reflected by the dichroic mirror 121 with high reflectance, and enter the beam dump 122.

The peripheral portion (aside from the aforementioned center portion) of the pulse laser beam 33 that has passed through the plasma generation region 25 may be reflected by the off-axis paraboloidal mirror 110a, and enter the beam dump 112 inside the sub-chamber 102 through the window 113.

The guide laser beam 43 that has entered the optical detection unit may be transmitted through the filter 126 and the imaging optical system 124. With this, the guide laser beam 43 may be imaged onto the optical sensor 125 by the imaging optical system 124.

The light 251 emitted from the plasma generated in the plasma generation region 25 may also travel through the space 115, as in the guide laser beam 43. The light 251 may then be incident on the reflective surface 120a at substantially 45 degrees. The light 251 reflected by the reflective surface 120a may be transmitted through the lens 128. The lens 128 may collimate the light 251. The collimated light 251 may be transmitted through the dichroic mirror 121 and the window 123, and enter the optical detection unit.

The light 251 that has entered the optical detection unit may be incident on the filter 126. The filter 126 may transmit, of the light 251, at least light at a predetermined wavelength. The light 251 transmitted through the filter 126 may then enter the imaging optical system 124. The imaging optical system 124 may image the entering light 251 onto the photosensitive surface of the optical sensor 125. With this, the image of the light 251 at the plasma generation region 25 may be transferred onto the optical sensor 125.

The etching gas H* supplied into the space 115 through the introduction pipe 92 from the etching gas supply unit 90 may flow into the chamber 2A along the surfaces of the optical elements provided in the beam path in the mirror unit 101A. The optical elements provided in the beam path in the mirror unit 101A may, for example, include the reflective surface 120a of the mirror block 120, the lens 128, and so forth. With this, debris deposited on the surfaces of the optical elements may be etched by the etching gas H*.

### 4.4.1.3 Effect

According to the first example, the guide laser beam 43 and the light 251 emitted from the plasma may be detected by the single optical sensor 125. With this, the focus of the pulse laser beam 33 and the position to which the target 27 is supplied may be detected with high precision.

Further, debris deposited on the surfaces of the optical elements may be etched. With this, the guide laser beam 43 and the light 251 may be detected stably for a relatively long time.

Here, when tin (Sn) is used as the target material, a hydrogen gas or hydrogen radicals may be used as the etching gas H*. The hydrogen gas or the hydrogen radicals may etch deposited Sn through the following chemical reaction:

Sn (solid)+2H₂ (gas)->SnH₄ (gas)

However, when the temperature reaches or exceeds 100° C., the reverse reaction may occur, and Sn may be deposited. Accordingly, the temperature of each optical element (e.g., the mirror unit 101A) may preferably be controlled to fall within a range of 30° C. to 80° C., where the etching reaction rate is faster than the deposition reaction rate. The temperature of the mirror unit 101A may, for example, be controlled by controlling at least one of the temperature and the flow rate of a heat carrier circulating in the mirror unit 101A based on the detection result of a temperature sensor (not shown) attached to the mirror unit 101A. The flow rate and/or the temperature of the heat carrier may be regulated by controlling a flow controller (not shown) or a chiller (not shown) connected to a flow channel (not shown) of the heat carrier.

### 4.4.2 Second Example

### 4.4.2.1 Configuration

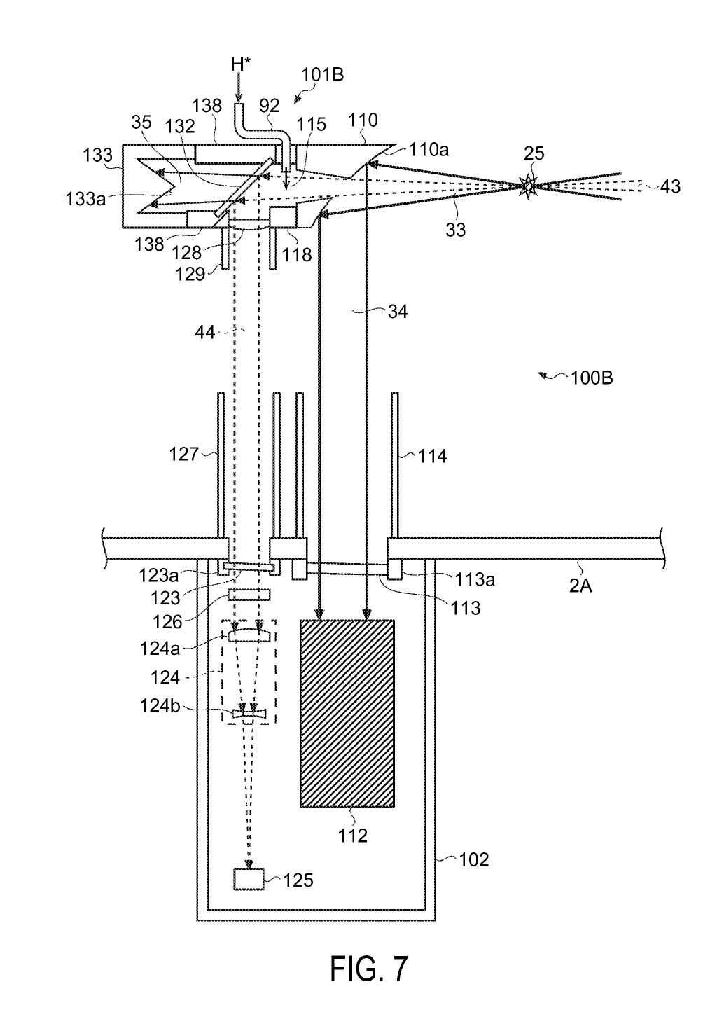

FIG. 7 schematically illustrates the configuration of an optical detection system 100B of a second example. As shown in FIG. 7, the optical detection system 100B may differ from the optical detection system 100A in that the mirror unit 101A is replaced by a mirror unit 101B. Further, in the optical detection system 100B, the dichroic mirror 121 and the beam dump 122 may be omitted.

The mirror unit 101B may include the mirror block 110, the lens block 118, a dichroic mirror block 138, and a beam dump block 133.

The mirror block 110 and the lens block 118 may be configured similarly to those shown in FIG. 6. A dichroic mirror 132 may be fixed to the dichroic mirror block 138. The dichroic mirror 132 may be coated with a film configured to transmit the pulse laser beam 33 with high transmittance and reflect the guide laser beam 43 and a part of the light 251 (see FIG. 2) with high reflectance. The substrate of the dichroic mirror 132 may, for example, be made of diamond.

Here, the lens 128 fixed to the lens block 118 may be made of a material that transmits the guide laser beam 43 and the light 251. The beam dump block 133 may include a conical surface 133a so that the pulse laser beam 33 is absorbed efficiently. The beam dump block 133 may be provided with a flow channel (not shown), through which a heat carrier may circulate to suppress a rise in temperature due to the energy of the laser beam. The introduction pipe 92 from the etching gas supply unit 90 (see FIG. 2) may be connected to the mirror unit 101B such that the etching gas H* flows along the respective surfaces of the dichroic mirror 132 and the lens 128.

### 4.4.2.2 Operation

The general operation of the optical detection system 100B shown in FIG. 7 will now be described. The beam axis of the guide laser beam 43 may substantially coincide with the beam axis of the pulse laser beam 33. The guide laser beam 43 may once be focused in the plasma generation region 25, and then the diverging guide laser beam 43 may travel through the space 115 in the mirror block 110. The guide laser beam 43 that has traveled through the space 115 may be incident on the dichroic mirror 132 at substantially 45 degrees. The guide laser beam 43 reflected by the dichroic mirror 132 may be collimated through the lens 128. The collimated guide laser beam 43 may pass through the window 123, and enter the optical detection unit inside the sub-chamber 102.

The center portion of the pulse laser beam 33 that has passed through the plasma generation region 25 may pass through the space 115, be transmitted through the dichroic mirror 132, and be incident on the conical surface 133a of the beam dump block 133.

The peripheral portion of the pulse laser beam 33 that has passed through the plasma generation region 25 may be reflected by the off-axis paraboloidal mirror 110a of the mirror block 110, and enter the beam dump 112 inside the sub-chamber 102 through the window 113.

The guide laser beam 43 that has entered the optical detection unit may be transmitted through the filter 126 and the imaging optical system 124. With this, the guide laser beam 43 may be imaged on the photosensitive surface of the optical sensor 125 by the imaging optical system 124.

A part of the light 251 emitted from the plasma generated in the plasma generation region 25 may travel through the space 115, as in the guide laser beam 43. The light 251 may then be incident on the dichroic mirror 132 at substantially 45 degrees. The light 251 reflected by the dichroic mirror 132 may be transmitted through the lens 128. The lens 128 may collimate the light 251. The collimated light 251 may be transmitted through the window 123 and enter the optical detection unit.

The light 251 that has entered the optical detection unit may be incident on the filter 126. The filter 126 may transmit, of the light 251, at least light at a predetermined wavelength. The light 251 transmitted through the filter 126 may then enter the imaging optical system 124. With this, the image of the light 251 at the plasma generation region 25 may be transferred onto the optical sensor 125.

The operation of etching the debris deposited on the optical elements provided in the beam path in the mirror unit 101B may be similar to that of the first example. Thus, detailed description thereof will be omitted.

### 4.4.2.3 Effect

According to the second example, the dichroic mirror 132 and the beam dump block 133 may be provided in the mirror unit 101B. Thus, the pulse laser beam 33, the guide laser beam 43, and the light 251 may be separated prior to passing through the lens 128. As a result, the lens 128 need not have durability against the high power pulse laser beam 33, and thus need not be formed of diamond, which is relatively expensive.

### 4.4.3 Third Example

### 4.4.3.1 Configuration

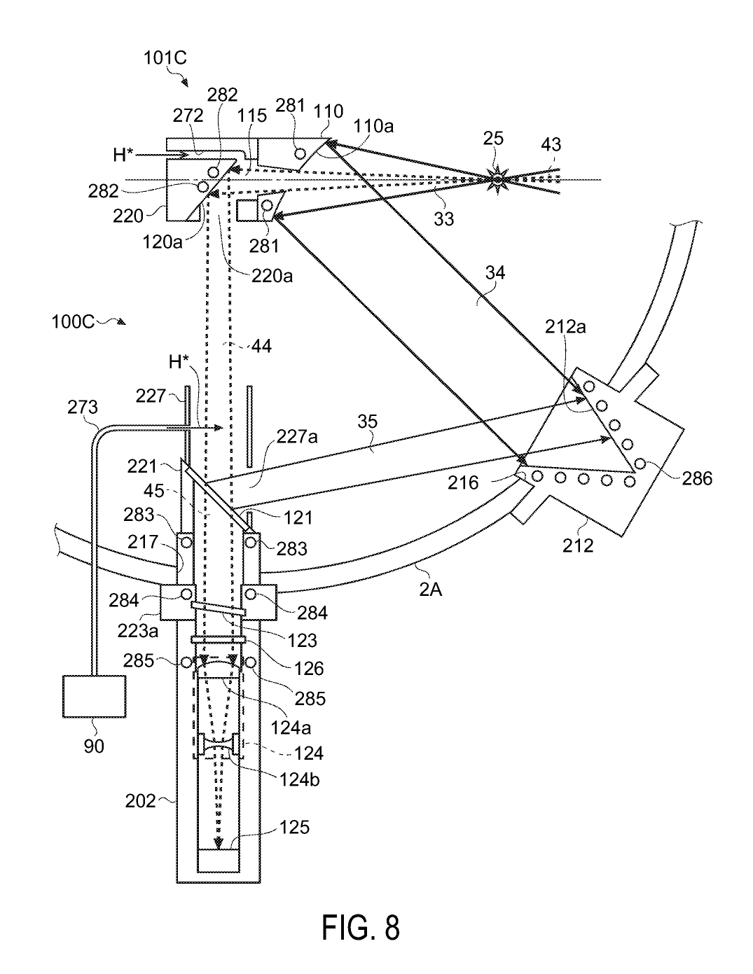

FIG. 8 schematically illustrates the configuration of an optical detection system 100C of a third example. As shown in FIG. 8, the optical detection system 100C may differ from the optical detection system 100A in that the mirror unit 101A is replaced by a mirror unit 101C. In the mirror unit 101C, the lens 128 and the lens block 118 for holding the lens 128 may be omitted. Further, in the optical detection system 100C, the beam dump 122 for the light 35 and the beam dump 112 for the light 34 may be replaced by a common beam dump unit 212.

More specifically, the mirror unit 101C may include the mirror block 110 and a mirror block 220. The mirror block 110 may be configured similarly to the mirror block 110 shown in FIG. 6. However, a flow channel 281 may preferably be provided inside the mirror block 110, through which a heat carrier supplied from a chiller (not shown) may flow.

The mirror block 220 may be configured similarly to the mirror block 120 shown in FIG. 6. However, in place of the introduction pipe 92 shown in FIG. 6, a channel 272 through which the etching gas H* supplied from the etching gas supply unit 90 flows via a pipe (not shown) may be formed inside the mirror block 220. Further, a flow channel 282 may preferably be provided inside the mirror block 220, as in the mirror block 110, through which a heat carrier supplied from a chiller (not shown) may flow.

The optical detection system 100C may include the dichroic mirror 121, the window 123, the imaging optical system 124, and the optical sensor 125. The window 123 may be held by a window holder 223a. The window holder 223a may be provided such that the window 123 covers a communication hole 217 formed in the chamber 2A. A flow channel 284 may preferably be provided in the window holder 223a, through which a heat carrier supplied from a chiller (not shown) may flow. Here, the window holder 223a and the mirror holder 221 may be formed integrally.

The dichroic mirror 121 may be held by the mirror holder 221. The mirror holder 221 may be provided so as project into the chamber 2A. The mirror holder 221 may hold the dichroic mirror 121 such that the dichroic mirror 121 is inclined with respect to the travel direction of the light 44 reflected by the reflective surface 120a of the mirror block 220. A flow channel 283 may preferably be provided in the mirror holder 221, through which a heat carrier supplied from a chiller (not shown) may flow. A baffle 227 may be provided on the dichroic mirror 121 to reduce the debris being deposited on the surface thereof on which the light 44 is incident. A through-hole 227a may be formed in the baffle 227, through which the light 35 reflected by the dichroic mirror 121 may travel toward the beam dump 212. Further, the interior space of the baffle 227 may be in communication with the etching gas supply unit 90 through a pipe 273. With this, the etching gas H* may be supplied from the etching gas supply unit 90 through the pipe 273 toward a surface of the dichroic mirror 121 which is exposed to a space in the chamber 2A.

The filter 126, the imaging optical system 124, and the optical sensor 125 may be provided inside a sub-chamber 202. The sub-chamber 202 may project to the outside of the chamber 2A. The positional relationship among the window 123, the filter 126, the imaging optical system 124, and the optical sensor 125 may be similar to that in the optical detection system 100A shown in FIG. 6. A flow channel 285 may preferably be provided in the sub-chamber 202, through which a heat carrier supplied from a chiller (not shown) may flow.

The beam dump unit 212 may be provided so as to cover a communication hole 216 formed in the chamber 2A. A V-shaped recess 212a may be formed in the beam dump unit 212 at a portion on which the light 34 and the light 35 may be incident. A flow channel 286 may preferably be provided near the recess 212a in the beam dump unit 212, through which a heat carrier supplied from a chiller (not shown) may flow.

### 4.4.3.2 Operation

The general operation of the optical detection system 100C shown in FIG. 8 will now be described. The beam axis of the guide laser beam 43 may substantially coincide with the beam axis of the pulse laser beam 33. The guide laser beam 43 may once be focused in the plasma generation region 25, and then the diverging guide laser beam 43 may travel through the space 115 in the mirror block 110. The guide laser beam 43 that has traveled through the space 115 may be incident on the reflective surface 120a of the mirror block 220 at substantially 45 degrees. The guide laser beam 43 reflected by the reflective surface 120a may pass through an opening 220a in the mirror block 220, be transmitted through the dichroic mirror 121 and the window 123, and enter the optical detection unit inside the sub-chamber 202.

The center portion of the pulse laser beam 33 that has passed through the plasma generation region 25 may also travel through the space 115, be reflected by the reflective surface 120a, and pass through the opening 220a, as in the guide laser beam 43. The pulse laser beam 33 that has passed through the opening 220a may be incident on the dichroic mirror 121 and be reflected thereby.

The peripheral portion of the pulse laser beam 33 that has passed through the plasma generation region 25 may be reflected by the off-axis paraboloidal mirror 110a of the mirror block 110, and enter the beam dump unit 212.

The guide laser beam 43 that has entered the optical detection unit may be transmitted through the filter 126 and the imaging optical system 124, as in the case shown in FIG. 6. With this, the image of the guide laser beam 43 at its focus may be imaged onto the optical sensor 125.

The light 251 (see FIG. 2) emitted from the plasma generated in the plasma generation region 25 may be reflected by the mirror block 220, be transmitted through the dichroic mirror 121 and the window 123, and enter the optical detection unit, as in the guide laser beam 43.

The etching gas H* supplied into the space 115 through the pipe 272 from the etching gas supply unit 90 may flow into the chamber 2A along the surfaces of the optical elements provided in the beam path in the mirror unit 101C. The optical elements provided in the mirror unit 101C may, for example, include the reflective surface 120a of the mirror block 220. With this, debris deposited on the surfaces of the optical elements may be etched by the etching gas H*.

### 4.4.3.3 Effect

According to the third example, the single beam dump unit 212 may be provided to absorb both the light 35 and the light 34. Further, since the light 35 and the light 34 may enter the beam dump unit 212 without being transmitted through the windows, heat generated from unnecessary light may be processed with a simple configuration.

Further, according to the third example, heat carriers may be made to flow in locations where the temperature may rise, such as the mirror unit 101A, the window holder 223a, the sub-chamber 202, and the beam dump unit 212. Accordingly, the deterioration in performance of the optical detection system 100C caused by the heat may be suppressed.

### 5. VARIATION

### 5.1 Configuration

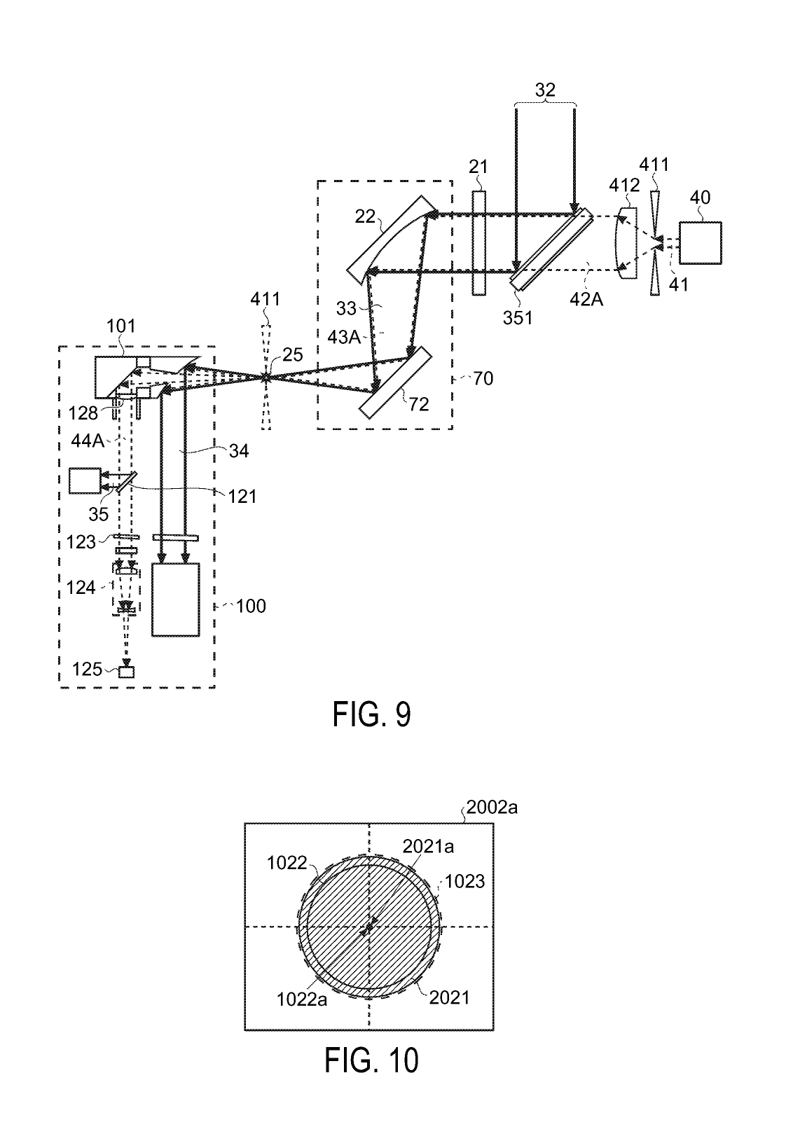

FIG. 9 schematically illustrates the configuration of an optical system in a modification of the EUV light generation system 11A. In FIG. 9, only the primary optical elements are illustrated. The omitted elements may be similar to those shown in FIG. 2, 6, 7, or 8.

As shown in FIG. 9, in the modification, a pinhole plate 411 and a lens 412 may be provided in place of the beam expander 401 in FIG. 2. Other configurations may be similar to those shown in FIG. 2. The pinhole plate 411 may be provided at the focus of the lens 412. The pinhole in the pinhole plate 411 may be smaller than the beam diameter of the guide laser beam 41 outputted from the guide laser device 40. Alternatively, the diameter of the pinhole may be set to the spot size of the pulse laser beam 33 in the plasma generation region 25.

### 5.2 Operation

With reference to FIG. 9, the guide laser beam 41 outputted from the guide laser device 40 may first be incident on the pinhole plate 411. Apart of the guide laser beam 41 which has passed through the pinhole in the pinhole plate 411 may be diverged and be incident on the lens 412. The lens 412 may collimate the guide laser beam 41. The beam diameter of a collimated guide laser beam 42A may substantially coincide with the beam diameter of the pulse laser beam 32.

The guide laser beam 42A may be transmitted through the dichroic mirror 351 of the beam adjusting unit 350 (see FIG. 2). The pulse laser beam 32 may be reflected by the dichroic mirror 351. With this, the beam axis of the pulse laser beam 32 may substantially coincide with the beam axis of the guide laser beam 42A. The guide laser beam 42A may travel through substantially the same beam path as the pulse laser beam 32, and be focused by the laser beam focusing optical system 70 in the plasma generation region 25 as a guide laser beam 43A. At this time, the image of the guide laser beam 41 at the pinhole in the pinhole plate 411 may be imaged at the focus of the laser beam focusing optical system 70 in the plasma generation region 25. For example, the image of the guide laser beam 41 at the pinhole in the pinhole plate 411 may be transferred with the same magnification in the plasma generation region 25 by adjusting the focal distance of the lens 412 for the wavelength of the guide laser beam 41 to the focal distance of the laser beam focusing optical system 70.

The guide laser beam 43A that has once been focused in the plasma generation region 25 may then enter the mirror unit 101 of the optical detection system 100. The diverging guide laser beam 43A may be reflected by one of the reflective surfaces of the mirror unit 101 as a guide laser beam 44A. The reflected guide laser beam 44A may be collimated through the lens 128, be transmitted through the dichroic mirror 121 and the window 123, and enter the imaging optical system 124. Thereafter, the guide laser beam 44A may be incident on the optical sensor 125 provided such that the photosensitive surface thereof lies at the focus of the imaging optical system 124. With this, the image of the guide laser beam 41 at the pinhole in the pinhole plate 411 may be imaged on the photosensitive surface of the optical sensor 125. The data on this image may be sent to the EUV light generation position controller 51.

FIG. 10 shows an image 2002a as an example of the relationship among the image of the guide laser beam 44A, the image of the light 251, and the image of the pulse laser beam 33. Here, FIG. 10 shows the image 1022 of the light 251 to be detected by the optical sensor 125 when the center of the target 27 coincides with the center of the pulse laser beam 33 at the time of being irradiated with the pulse laser beam 33 and an image 2021 of the guide laser beam 41 at the pinhole in the pinhole plate 411.

As shown in FIG. 10, in the modification, the image 2021 may substantially coincide with an image 1023 of the pulse laser beam 33. Since the guide laser beam 42A/43A may travel through substantially the same beam path as the pulse laser beam 32/33 and have substantially the same beam diameter as the pulse laser beam 32/33, the image 2021 may reflect the spot size of the pulse laser beam 33. Further, in the image 2002a, the center 2021a of the image 2021 and the center 1022a of an image 1022 of the light 251 may be calculated. The EUV light generation position controller 51 may control the focus of the pulse laser beam 33 and the position to which the target 27 is supplied based on the calculated data. With this, the center 2021a of the image 2021 may coincide with the center 1022a of the image 1022. Here, the focus of the pulse laser beam 33 and the position to which the target 27 is supplied may be controlled so that the centers of the respective images are at the ideal position (e.g., the intersection of the broken lines in the image 2002a). Here, in place of the centers of the respective images, the centroids of the respective images may be obtained.

### 5.3 Effect

According to the modification, the beam diameter of the guide laser beam 42A and the beam diameter of the pulse laser beam 32 may be made to substantially coincide with each other. Further, the image of the guide laser beam 41 at the pinhole in the pinhole plate 411 may be imaged in the plasma generation region 25. Accordingly, the center and the beam diameter of the pulse laser beam 33 may be detected based on the detection result of the image 2021 of the guide laser beam 41. As a result, the positional relationship between the pulse laser beam 33 and the light 251 may be detected with high precision.

The above-described embodiments and the modifications thereof are merely examples for implementing this disclosure, and this disclosure is not limited thereto. Making various modifications according to the specifications or the like is within the scope of this disclosure, and other various embodiments are possible within the scope of this disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as at least one or “one or more.”

What is claimed is:

1. An apparatus for generating extreme ultraviolet light used with a first laser device configured to output a first laser beam, the apparatus comprising:
a second laser device configured to output a second laser beam;
a beam adjusting unit configured to cause a beam axis of the first laser beam and a beam axis of the second laser beam to substantially coincide with each other;
a chamber having a window through which the first and second laser beams are introduced into the chamber;
a target supply unit configured to supply a target material to a predetermined region inside the chamber;
a laser beam focusing optical system for focusing the first laser beam on the target material inside the chamber;
an optical detection system for detecting the second laser beam and light emitted from plasma generated when the target material is irradiated with the first laser beam;
a focus position correction mechanism configured to correct a position at which the first laser beam is focused by the laser beam focusing optical system;
a target supply position correction mechanism configured to correct a position to which the target material is supplied; and
a controller configured to control the focus position correction mechanism and the target supply position correction mechanism based on the detection result of the second laser beam and the light emitted from the plasma.

2. The apparatus according to claim 1, wherein the controller is configured to:
calculate a center of the second laser beam and a center of the light emitted from the plasma from the detection result of the optical detection system; and
control a position at which the first laser beam is focused by the laser beam focusing optical system and a position to which the target material is supplied by the target supplied unit so that the respective centers coincide with a predetermined position.

3. The apparatus according to claim 2, wherein the predetermined position is specified by an external apparatus.

4. The apparatus according to claim 1, wherein the controller is configured to:
calculate a centroid of the second laser beam and a centroid of the light emitted from the plasma from the detection result of the optical detection system; and
control a position at which the first laser beam is focused by the laser beam focusing optical system and a position to which the target material is supplied by the target supplied unit so that the respective centroids coincide with a predetermined position.

5. The apparatus according to claim 4, wherein the predetermined position is specified by an external apparatus.

6. The apparatus according to claim 1, wherein the optical detection system is provided downstream from the predetermined region in a beam path of the second laser beam.

7. The apparatus according to claim 1, wherein the second laser device is configured to output the second laser beam continuously.

8. The apparatus according to claim 1, wherein the second laser beam is visible radiation.

9. The apparatus according to claim 1, wherein the beam adjusting unit includes a dichroic mirror.

10. The apparatus according to claim 1, further comprising a dichroic mirror provided downstream from the predetermined region.

11. The apparatus according to claim 10, further comprising:
a holder for the dichroic mirror; and
a first cooling mechanism for cooling the holder.

12. The apparatus according to claim 10, further comprising a baffle provided to surround a surface of the dichroic mirror.

13. The apparatus according to claim 11, further comprising:
a beam dump provided in a beam path of the first laser beam reflected by the dichroic mirror; and
a second cooling mechanism for cooling the beam dump.

14. A method for generating extreme ultraviolet light in an apparatus that is used with a first laser device configured to output a first laser beam and includes a second laser device configured to output a second laser beam, a beam adjusting unit, a chamber, a target supply unit, a laser beam focusing optical system, an optical detection system, and a controller, the method comprising:
detecting the second laser beam;
detecting light emitted from plasma generated when a target material is irradiated with the first laser beam;
controlling a position at which the first laser beam is focused by the laser beam focusing optical system based on the detection result of the second laser beam; and
controlling a position to which the target material is supplied by the target supply unit based on the detection result of the light emitted from the plasma.
